(19) United States
(12) Patent Application Publication
(10) Pub. No.: US 2003/0084445 A1
(43) Pub. Date: May 1, 2003

(54) Method of enhancing awareness of a data cell in a grid

(76) Inventor: Paul Pilat, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/003,826

(22) Filed: Oct. 30, 2001

(51) Int. Cl. G06F 3/00; H04N 5/445; G06F 13/00

(52) U.S. Cl. 725/44; 725/40; 725/39

(57) ABSTRACT

An electronic programming guide includes an enhanced program listing for at least one of the program listings of the EPG. The enhanced program listing may comprise 3D text, a 3D still image, or 3D animation that appears higher than other program listings of the EPG grid in 3D space. The enhanced program listing may also include other content, such as audio clips, video clips, and icons indicating availability of associated interactive content available over the Internet.

### BACKGROUND

This invention relates generally to electronic programming guides for facilitating the selection, viewing, and recording of television programs or other multimedia content.

Electronic programming guides (EPGs) typically display a two dimensional (2D) grid of television (TV) program times on one axis and television channels or service providers on another axis. The EPG grid may include particular TV programs arranged by channel and time of presentation. The user can select any of the programs in the EPG for viewing or recording. This is usually done by selecting a particular program listing using a remote control device to cause the selected program to be automatically tuned or automatically scheduled for recording or subsequent (future) viewing. EPGs typically display limited information about a TV program. The information is usually limited to the title of the program, the time it is broadcast, and the channel broadcasting the program. The information is typically presented in a static text format, with the title resident in the grid slot associated with a particular time and channel combination. In some EPGs, another user interface action (such as activation of another button on the remote control device) may be required to obtain additional information about the selected program (e.g., program summary, content rating, critic's rating, status, actors, actresses and director, and so on).

### BRIEF DESCRIPTION OF THE DRAWINGS

The features and advantages of the present invention will become apparent from the following detailed description of the present invention in which:

FIG. 1 is an example of a display of a portion of an electronic program guide (EPG) in accordance with an embodiment of the present invention;

FIG. 2 is a flow chart for a process of providing an enhanced program listing in an EPG in accordance with an embodiment of the present invention;

FIG. 3 is a front view of a processor-based system in accordance with an embodiment of the present invention; and

FIG. 4 is a block diagram of a processor-based system in accordance with an embodiment of the present invention.

### DETAILED DESCRIPTION

Embodiments of the present invention comprise a feature of an electronic program guide (EPG) that allows TV program listings aligned on a two dimensional (2D) or three dimensional (3D) grid to be modified in a such a way as to enhance awareness of a particular program listing occurring in a data cell of the EPG. In a 2D EPG, the program listing may be accentuated via highlights or flashing images, for example. In a 3D EPG, the program listing may “rise out” (or be otherwise accented) above the normal surface level of other program listings in the grid, thereby bringing certain TV programs to the attention of a viewer (i.e., highlighting the programs). Such highlighting may occur when the viewer scrolls around the EPG display in such a manner as to cause a predetermined TV program listing to be in view on the EPG display. After the viewer scrolls past the associated time slot such that the predetermined program listing is no longer visible, the TV program listing reverts back to its original condition. In one embodiment, the EPG display comprises a 3D image shown on a display and the predetermined TV program listing appears to “rise up” or “pop out” of the EPG display in 3D space when viewed by the viewer. The predetermined TV program listing may include text or images, but the present invention is not limited in this respect. In one embodiment, the predetermined TV program listing highlighted on the EPG display includes animated images or animated characters.

Reference in the specification to “one embodiment” or “an embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

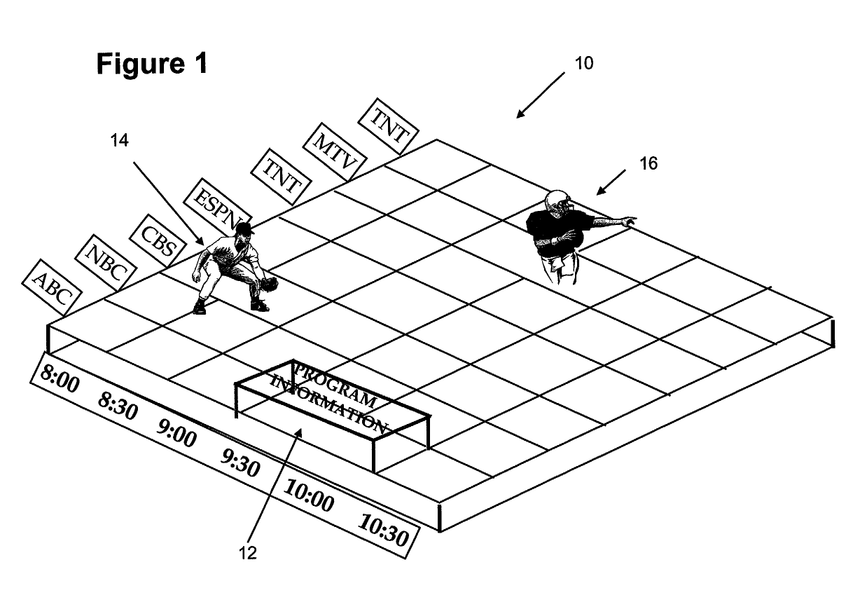

Referring to FIG. 1, a sample portion of an EPG graphical user interface 10 may include a series of program times corresponding to a current time and date and a series of channels, TV service providers, or TV networks such as ABC, CBS, etc. A plurality of programs may be shown according to time and service provider. Conventionally, the user may select a given program for viewing or recording using a remote control device. In one embodiment, the EPG display may be in a 2D format (e.g., a conventional grid having time on one axis and channels on another axis) having a plurality of data cells. In other embodiments, the EPG display may be in a 3D format, where a third dimension may be included to give the appearance of depth to the conventional 2D grid using known 3D computer graphics techniques.

As shown in the example of FIG. 1, according to embodiments of the present invention, data cells of the EPG grid may include one or more special entries for TV program listings in the EPG. In order to highlight or promote a particular TV program to a viewer, the EPG provider may include an enhanced TV program listing that changes its appearance as the viewer scrolls around the EPG display. When a predetermined TV program listing comes into view on the EPG display, one embodiment of the present invention may cause the predetermined TV program listing 12 to “rise out” above the normal level of the grid used for other program listings. This “rise out” may include changing the appearance of that slot of the EPG grid as it is displayed to the viewer such that the program listing appears higher in 3D space than other program listings. This change in appearance causes the predetermined program listing to stand out among the other program listings as an “enhanced” program listing and get the viewer's attention. This may be desired for promotional purposes. In other embodiments, within the EPG display, multiple different enhanced program listings currently in view may be shown at different levels of 3D space above the grid used for other program listings.

In various embodiments, the enhanced program listing includes text and/or images. In one simple example, the name of the TV program may be raised above the normal level of the grid. In another example, the program name, a logo or other symbol representing a TV program may be brightened, flashed, or otherwise modified to attract the attention of the viewer. The enhanced program listing is thus represented in a manner differently than surrounding program listings in the EPG in order to get the viewer's attention. In another embodiment, the enhanced program listing may comprise either 2D or 3D, stationary or animated images (including logos, icons, characters, and so on). For example, if a baseball game is being televised, an animated baseball player 14 may “rise up” from the appropriate slot of the EPG display when the time slot and channel for the baseball game broadcast comes into current view on the EPG display during viewer-initiated scrolling. The animated baseball player may then move in some fashion to attract the attention of the viewer. Alternatively, the baseball player image may appear stationary. Similarly, an animated football player 16 may be used to identify broadcast of a football game. As can be appreciated, many other images (including icons and logos) and animations can be used in the EPG display to identify current or future broadcast of TV programs. As another example, an animated image of a well-known character of a TV program (either live action or cartoon) may be used as an enhanced program listing in the EPG display to identify broadcast of the TV program. In one embodiment, an icon may be used as part of the enhanced program listing to indicate that the program is associated with interactive content available over the Internet or other communications network. For each of the above-described embodiments, well-known techniques of 2D and 3D computer graphics and computer animation may be employed to display the enhanced program listing.

In another embodiment, the enhanced program listing may include an audio component or segment. An audio clip may be rendered for perception by the viewer of the EPG when the enhanced program listing is activated due to viewer scrolling or other presentation of a relevant portion of the EPG to the viewer. For example, when the baseball program listing 14 is enhanced visually according to the present invention, an audio clip of the theme music of the program or other sound effects may also be rendered.

In yet another embodiment, selection of an enhanced program listing by the viewer using some mechanism of interactivity after perception of the enhanced program listing may commence display of a video clip concerning the selected program. For example, selecting the animated baseball player 14 using a remote control device by the viewer may cause a short video clip to be displayed on all or a portion of the display, thereby giving a preview of the upcoming game. In another example, selection of the enhanced program listing may cause the display of a preview, advertisement, or “trailer” of the program on all or a portion of the display.

Insertion of enhanced program listings according to embodiments of the present invention may create a new business opportunity for EPG providers. Interested promoters, sponsors, and developers of TV programming or other multimedia content may purchase the rights to enhanced EPG “real estate” from an EPG provider. The rights may include the exclusive ability to promote a type of programming or a specific program in the EPG (e.g., exclusive rights to baseball broadcasts, exclusive rights to promote a program in a particular broadcast time slot, and so on) using the enhanced TV program listing of the present invention.

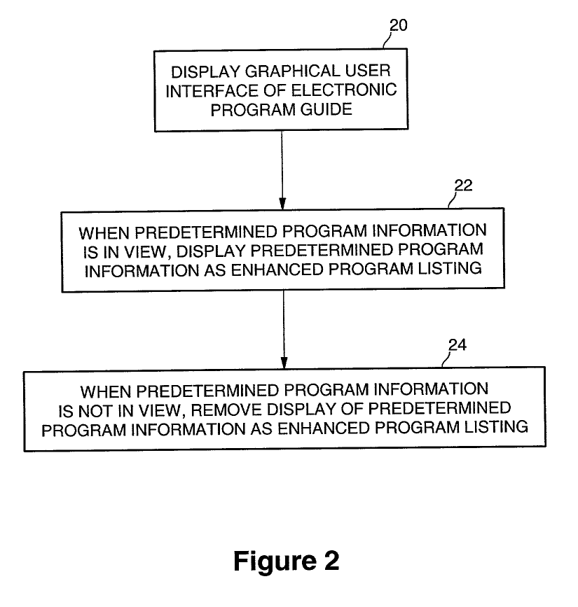

FIG. 2 is a flow chart for a process of providing an enhanced program listing in an EPG in accordance with an embodiment of the present invention. At block 20, a graphical user interface of an EPG may be displayed for a viewer. The viewer may view the currently displayed portion of the EPG, or the viewer may interact with the EPG to cause the display of other portions of the EPG using any available interface mechanism. At block 22, when predetermined program information is in view on the display as a portion of the EPG, the predetermined program information may be displayed as an enhanced program listing. As discussed above, this may include rendering a 3D graphic “rise” and/or by commencing animation. The graphics may be positioned and/or originate at the location (e.g., the time slot) within the EPG grid for the program. At block 24, when the predetermined program information is not in view (e.g., when the viewer scrolls the EPG display such that the program listing is not visible), the predetermined program information represented as an enhanced program listing may be removed from the display and/or the animation may be halted. In one embodiment, after the predetermined program information is represented as an enhanced program listing (i.e., a 3D rise and/or an animated sequence) for a predetermined period of time, the display of the enhanced program listing is removed, regardless of any viewer interaction.

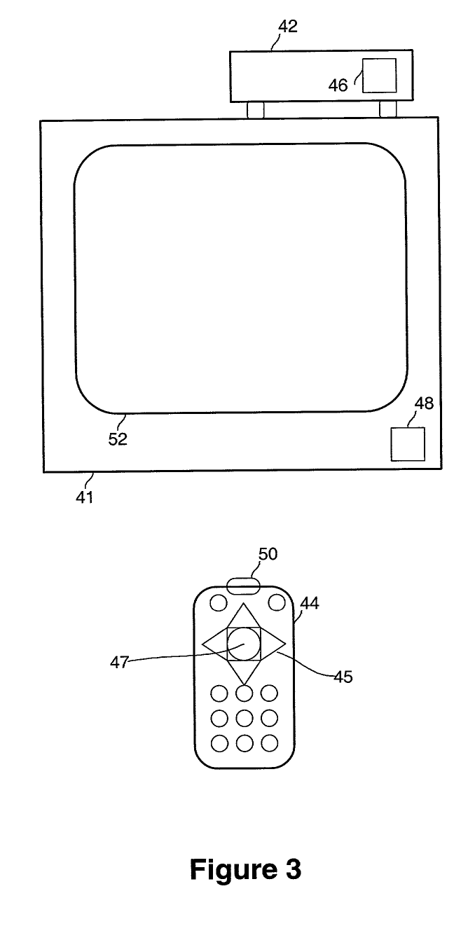

Referring to FIG. 3, in accordance with one embodiment of the present invention, software implementing the enhanced program listing of the present invention may be stored in and executed by a set-top box 42 that rests atop or near a television receiver 41 having a display screen 52. In other embodiments, a personal computer (PC) or other processing system may used in place of the set-top box. A remote control unit 44 interface 50 may control the television receiver 44, through its interface 48 and the set-top box 42, through its interface 46. The interfaces 50, 48 and 46 may be wireless interfaces, such as infrared interfaces in accordance with one embodiment of the present invention. Although a TV is shown in FIG. 3 as the display device, other displays such as computer monitors may also be used.

A plurality of highlight navigation keys 45 and a select key 47 may be provided on the remote control unit 44 for selection of the various icons shown in the graphical user interface of FIG. 1. Particularly, the navigation keys 45 may be utilized to move the highlighting of a program to the desired grid entry having predetermined program information that may be selected using the select button 47.

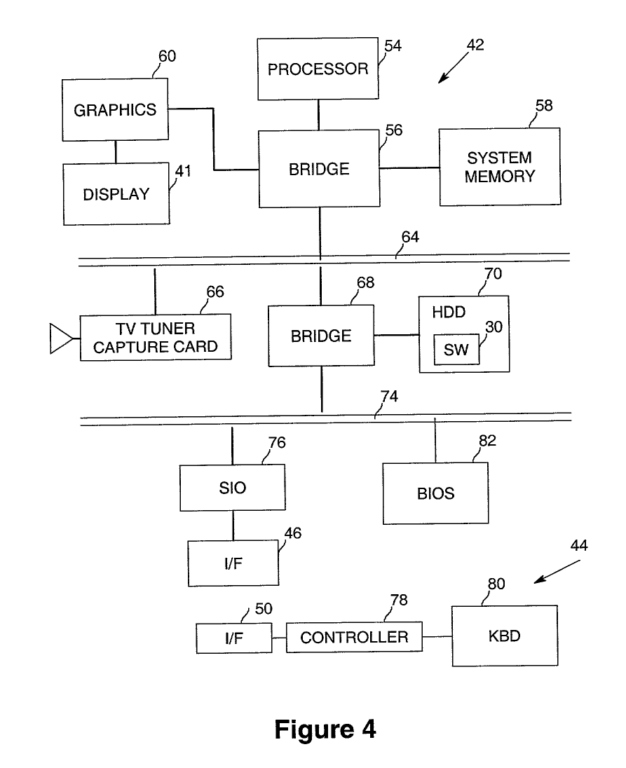

Referring to FIG. 4, the set-top box 42 may include a processor 54 coupled to a bridge 56. The bridge 56 may couple a graphics accelerator 60 and a system memory 58. The graphics accelerator 60 may be coupled to the television receiver 41 in one embodiment of the present invention.

The bridge 56 may also couple to a bus 64 that may couple to a television tuner/capture card 66. The card 66 may be coupled to a video source such as a cable or satellite receiver as two examples. The bus 64 may also be coupled to a bridge 68. The bridge 68 may be coupled to a hard disk drive (HDD) 70 that stores software 30 implementing the enhanced program listing feature embodied in the present invention.

The bridge 68 may also be coupled to a bus 74. The bus 74 couples a serial input/output (SIO) device 76 and a basic input/output system (BIOS) storage 82. The SIO device 76 in turn is coupled to the interface 46 that communicates with the remote control unit 44. Particularly, the remote control unit 44 may include it's own interface 50 coupled to a controller 78. The controller 78 receives input commands from a keypad 80.

The techniques described herein are not limited to any particular hardware or software configuration; they may find applicability in any computing or processing environment. The techniques may be implemented in hardware, software, or a combination of the two. The techniques may be implemented in programs executing on programmable machines such as mobile or stationary computers, set-top boxes, personal digital assistants, and similar devices that each include a processor, a storage medium readable by the processor (including volatile and non-volatile memory and/or storage elements), at least one input device, and one or more output devices. Program code is applied to the data entered using the input device to perform the functions described and to generate output information. The output information may be applied to one or more output devices.

Each program may be implemented in a high level procedural or object oriented programming language to communicate with a processing system. However, programs may be implemented in assembly or machine language, if desired. In any case, the language may be compiled or interpreted.

Each such program may be stored on a storage medium or device, e.g., compact read only memory (CD-ROM), digital versatile disk (DVD), hard disk, magnetic disk, or similar medium or device, that is readable by a general or special purpose programmable machine for configuring and operating the machine when the storage medium or device is read by the computer to perform the procedures described herein. The system may also be considered to be implemented as a machine-readable storage medium, configured with a program, where the storage medium so configured causes a machine to operate in a specific manner. Other embodiments are within the scope of the following claims.

While the present invention has been described with respect to a limited number of embodiments, those skilled in the art will appreciate numerous modifications and variations. It is intended that the appended claims cover all such modifications and variations as fall within the true spirit and scope of this present invention.

What is claimed is:

1. A method comprising:
displaying a portion of an electronic program guide (EPG); and
displaying an enhanced program listing for at least one of the program listings of the EPG portion.

2. The method of claim 1, wherein the enhanced program listing comprises text displayed differently than program listings surrounding the enhanced program listing in the EPG portion.

3. The method of claim 1, wherein the EPG comprises a three dimensional (3D) EPG and displaying the enhanced program listing comprises displaying the enhanced program listing as a 3D graphic text appearing above the level of other program listings of the EPG portion in 3D space.

4. The method of claim 1, wherein the EPG comprises a 3D EPG and displaying the enhanced program listing comprises displaying the enhanced program listing as a 3D graphic image appearing above the level of other program listings of the EPG portion in 3D space.

5. The method of claim 4, wherein the 3D graphic image comprises a logo identifying a television program described by the enhanced program listing.

6. The method of claim 4, wherein the 3D graphic image comprises a character image identifying a character of a television program described by the enhanced program listing.

7. The method of claim 1, wherein the EPG comprises a 3D EPG and displaying the enhanced program listing comprises displaying the enhanced program listing as animation appearing above the level of other program listings of the EPG portion.

8. The method of claim 1, wherein the EPG comprises a 3D EPG and further comprising displaying a plurality of enhanced program listings at different heights of 3D space above a level of other program listings within the EPG portion.

9. The method of claim 1, further comprising removing the display of the enhanced program listing.

10. The method of claim 1, further comprising rendering an audio segment associated with display of the enhanced program listing for perception by a viewer of the EPG.

11. The method of claim 1, further comprising displaying a video clip associated with the enhanced program listing on at least a portion of a display.

12. The method of claim 1, wherein displaying the enhanced program listing comprises displaying an icon indicating that interactive content associated with a program identified by the enhanced program listing is available for access over the Internet.

13. The method of claim 1, further comprising accepting an enhanced program listing for inclusion in the EPG in return for value.

14. An article comprising a medium storing instructions that enable a processor-based system to:
display a portion of an electronic program guide (EPG); and
display an enhanced program listing for at least one of the program listings of the EPG portion.

15. The article of claim 14, wherein the enhanced program listing comprises text displayed differently than program listings surrounding the enhanced program listing in the EPG portion.

16. The article of claim 14, wherein the EPG comprises a three dimensional (3D) EPG and instructions to display the enhanced program listing comprise instructions to display the enhanced program listing as a 3D graphic text appearing above the level of other program listings of the EPG portion in 3D space.

17. The article of claim 14, wherein the EPG comprises a 3D EPG and instructions to display the enhanced program listing comprise instructions to display the enhanced program listing as a 3D graphic image appearing above the level of other program listings of the EPG portion in 3D space.

18. The article of claim 17, wherein the 3D graphic image comprises a logo identifying a television program described by the enhanced program listing.

19. The article of claim 17, wherein the 3D graphic image comprises a character image identifying a character of a television program described by the enhanced program listing.

20. The article of claim 14, wherein the EPG comprises a 3D EPG and instructions to display the enhanced program listing comprise instructions to display the enhanced program listing as animation appearing above the level of other program listings of the EPG portion.

21. The article of claim 14, wherein the EPG comprises a 3D EPG and further comprising instructions to display a plurality of enhanced program listings at different heights of 3D space above a level of other program listings within the EPG portion.

22. The article of claim 14, further comprising instructions to remove the display of the enhanced program listing.

23. The article of claim 14, further comprising instructions to render an audio segment associated with display of the enhanced program listing for perception by a viewer of the EPG.

24. The article of claim 14, further comprising instructions to display a video clip associated with the enhanced program listing on at least a portion of a display.

25. The article of claim 14, wherein instructions to display the enhanced program listing comprises instructions to display an icon indicating that interactive content associated with a program identified by the enhanced program listing is available for access over the Internet.
